(19) United States
(12) Patent Application Publication
(10) Pub. No.: US 2008/0211958 A1
(43) Pub. Date: Sep. 4, 2008

(54) Dehumidified Equipment Housing

(75) Inventors: Thomas F. Berkey, Tavernier, FL (US); Ovidiu Neiconi, Boynton Beach, FL (US)

Correspondence Address: IP LEGAL DEPARTMENT;TYCO FIRE & SECURITY SERVICES, ONE TOWN CENTER ROAD, BOCA RATON, FL, 33486, US

(73) Assignee: Sensormatic Electronics Corporation, Boca, FL (US)

(21) Appl. No.: 11/791,179

(22) PCT Filed: Nov. 23, 2005
(86) PCT No.: PCT/US2005/042836

§ 371 Date: Mar. 28, 2008

Related U.S. Application Data
(60) Provisional application No. 60/630,350, filed on Nov. 23, 2004.

(51) Int. Cl. F24F 7/06; H04N 5/225

(52) U.S. Cl. 348/373; 454/236

(57) ABSTRACT

A dehumidified equipment housing may be used to house equipment including one or more mechanical devices and/or electronic devices. The dehumidified equipment housing may prevent condensation on one or more regions inside of the housing and may control condensation inside of the housing to provide a dehumidified environment inside of the housing. The dehumidified equipment housing may also remove condensed water to outside of the housing.

### CROSS-REFERENCE TO RELATED APPLICATIONS

This application claims the benefit of co-pending U.S. Provisional Patent Application Ser. No. 60/630,350, filed on Nov. 23, 2004, which is fully incorporated herein by reference.

### TECHNICAL FIELD

The present invention relates to equipment housings, and more particularly, to a dehumidified equipment housing including a dehumidification system.

### BACKGROUND INFORMATION

Equipment such as a mechanical or electrical device may not function properly if it is subjected to moisture or condensation. Enclosures may protect such devices from dripping water on the outside but may not prevent direct condensation from forming inside the enclosure, for example, during extreme temperature cycling. When the environment around an enclosure cools, the inside walls of the enclosure may cool and the air inside may eventually cool. When the inside air cools, the relative pressure inside the enclosure may drop, drawing external air into the enclosure (e.g., through leaks in the enclosure), for example, when the enclosure is rapidly cooled in a rainstorm. The external air may be near 100% relative humidity. The relative humidity of the air inside the enclosure may eventually reach the relative humidity of the external air outside the enclosure, and when cooled further, may cause condensation inside of the enclosure.

One type of equipment enclosure is an outdoor video dome for a video camera. A video dome enclosure may be mounted above an area of interest and may have an optically clear or transparent bubble forming the bottom half of the enclosure. An integral pan-tilt-zoom mechanism may be used to observe the area of interest (e.g., parking lots, security gates, building entrances and etc.) usually below and to the sides of the dome. Existing outdoor video dome enclosures may have a condensation problem, especially when located in a coastal humid environment. Condensation on the inside or outside of the bubble may render the dome useless. Condensation on the inside may form a haze on the bubble that obscures the view and may also collect into droplets that run down into the bottom of the bubble to obscure the view. The life of the electronics and mechanical components in the enclosure may also be shortened through corrosion caused by condensation.

Sealed enclosures have been designed to prevent air from entering. Sealed enclosures may leak, however, when subjected to relatively high differential pressures between the inside and outside of the enclosure. Sealed enclosures may be even more difficult to seal when cables need to be run through the walls or top of the enclosure. A hermetically sealed enclosure solution may work under ideal conditions, but in many cases, is too cost prohibitive and unreliable.

### BRIEF DESCRIPTION OF THE DRAWINGS

These and other features and advantages will be better understood by reading the following detailed description, taken together with the drawings wherein:

FIG. 1 is a schematic diagram of a dehumidified equipment housing, consistent with one embodiment of the present invention.

FIG. 2 is a cross-sectional view of a dehumidified equipment housing, consistent with another embodiment of the present invention.

FIG. 3 is a partially cross-sectional view of a dehumidified equipment housing, consistent with yet another embodiment of the present invention.

FIG. 4 is a perspective view of one embodiment of a heat transfer device and drain system.

### DETAILED DESCRIPTION

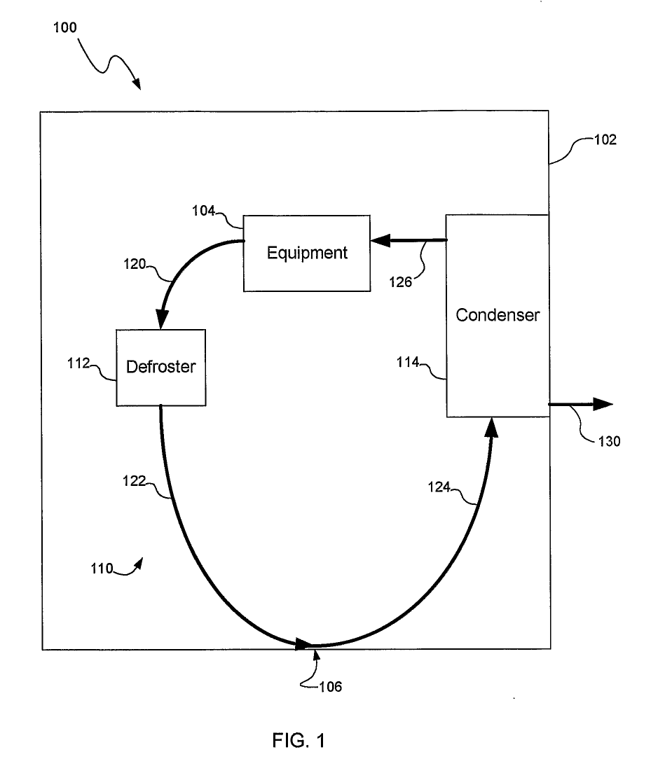

Referring to FIG. 1, a dehumidified equipment housing 100 may be used to house equipment including one or more mechanical devices and/or electronic devices. The dehumidified equipment housing 100 may prevent condensation on one or more regions inside of the housing 100 and may control condensation inside the housing 100 to provide a dehumidified environment inside of the housing 100. The dehumidified equipment housing 100 may also remove condensed water to outside of the housing 100.

The dehumidified equipment housing 100 may include an equipment enclosure 102 that encloses equipment 104 and a dehumidification system 110. The dehumidification system 110 may include a defroster 112 that prevents condensation on at least one target region 106 in the enclosure 102 and a condenser 114 that condenses and removes moisture in the air within the enclosure 102. In one embodiment, the enclosure 102 encloses a camera and the target region 106 includes a transparent region on the enclosure 102, as will be described in greater detail below. Those skilled in the art will recognize that the dehumidification system 110 may also be used to prevent condensation on other regions within the enclosure 102.

The defroster 112 may include a fan to direct the air flow and an auxiliary heater to heat the air. The condenser 114 may include a thermal transfer device, such as a heat sink integrated into a side of the enclosure 102, to cause the condensation. The condenser 114 may also include a drain system to remove water. One embodiment of a dehumidification system including a fan, heater, thermal transfer device, and drain system is described in greater detail below.

In operation, the defroster 112 may receive an air flow 120 from the equipment 104 and may direct an air flow 122 including heated air to the target region 106 (e.g., on an inside surface of the equipment enclosure 102). The equipment 104 and/or the defroster 112 may provide the heating to generate heated air in the air flow 122. The defroster 112 may also increase the rate and turbulence of the air flow 122. When the air flow 122 on the target region 106 is warmer, faster and more turbulent, condensation on the target region 106 is less likely. In one example, the temperature of the air in the air flow 122 may be in the range of about 10° C. and the flow rate of the air flow 122 may be in the range of about 10 CFM.

The condenser 114 may receive an air flow 124 from the target region 106 and may condense moisture in the condenser 114 to produce water 130. As a result of passing over the target region 106 (e.g., on a surface of the enclosure 102), the air in the air flow 124 may be partially cooled and the air flow 124 may be slowed, for example, to a lamellar flow. When the air flow 124 is a cooler, lamellar flow, condensation may be increased as the air flow 124 passes over or through the condenser 114. The condenser 114 may also direct an air flow 126 including dehumidified cooler air to the equipment 104 to cool the equipment 104. The water 130 removed from the air flow 124 may be directed outside of the enclosure 102, as described in greater detail below.

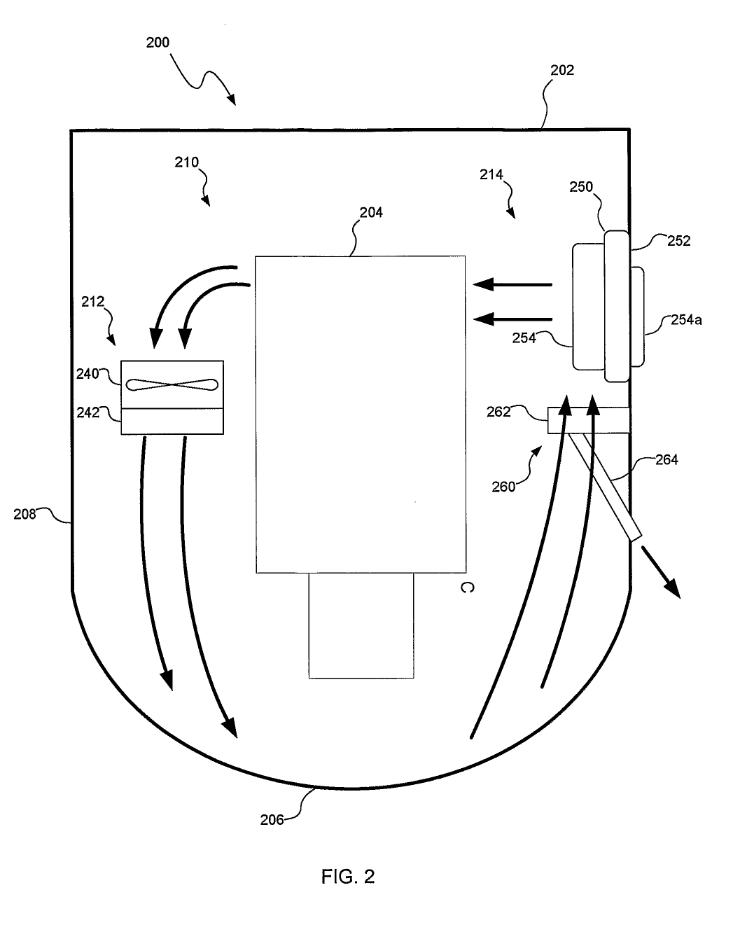

Referring to FIG. 2, one embodiment of a dehumidified housing 200 is described in greater detail. According to this embodiment, the dehumidified housing 200 includes a dome enclosure 202 configured to enclose video camera equipment 204. The dome enclosure 202 may include a transparent bubble portion 206 and a main enclosure portion 208. The main enclosure portion 208 protects and supports the camera equipment 204 and may be made of a metal material. The transparent bubble portion 206 protects the camera while providing an unimpeded field of view for the camera and may be made of a transparent plastic material. Examples of enclosures designed for cameras include the video dome housings available under the name SpeedDome® from Tyco Fire and Security.

This embodiment of the dehumidified housing 200 may house a dehumidification system 210 that prevents condensation on a target region on the transparent bubble portion 206. According to this embodiment of the dehumidification system 210, a defroster 212 may include a fan 240 and an auxiliary heater 242. The fan 240 draws the air from heat-generating electronics in the camera equipment 204 and discharges the air through the auxiliary heater 242, directing the air to the transparent bubble portion 206. The auxiliary heater 242 may heat the air to lower the relative humidity in the air, which further prevents condensation on the transparent bubble portion 206. Thus, the warmest, fastest and most turbulent air flow in the enclosure 202 may be forced over the bubble portion 206 to prevent condensation or “fogging” on the bubble portion 206.

The use of the auxiliary heater 242 may depend on the temperature outside of the enclosure 202. In general, a drop in temperature inside the enclosure 202 below the previous ambient temperature may facilitate the condensation of moisture. If the temperature outside of the enclosure 202 is below freezing, however, the temperature inside of the enclosure 202 may need to be raised to prevent the formation of frost or ice on the bubble portion 206. The heater 242 may be used when needed, therefore, to provide enough heat to prevent condensation (or to defrost) the bubble portion 206 without adversely affecting the controlled condensation of moisture by the dehumidification system 210. In one embodiment, the heater 242 may only be used when the external temperature has dropped rapidly to a new low or when heat from the equipment 204 is not enough to prevent ice from depositing on the outside of the bubble portion 206. The heater 242 may be set to maintain a desired temperature range inside of the enclosure 202. The heater 242 may be turned on, for example, when the inside temperature falls below −5° C. and may be turned off when the inside temperature rises above 0° C.

According to this embodiment of the dehumidification system 210, a condenser 214 may include a thermal transfer device 250, such as a heat sink or cold plate, integrated in a side of the equipment enclosure 202. The partially cooled air from the transparent bubble portion 206 may be channeled to pass over the thermal transfer device 250 as a generally lamellar flow. The thermal transfer device 250 may transfer heat from the partially cooled air to further cool the air, causing humidity in the air to condense and drop out as water. The thermal transfer device 250 may be located generally in an upper portion of the enclosure 202 where condensation is more likely because of the tendency of humid air to rise.

The thermal transfer device 250 may include one side 252 in contact with the outside environment and fins 254 extending inside of the enclosure 202 to facilitate heat transfer from the air inside the enclosure 202 to the outside. The thermal transfer device 250 may also optionally include fins 254a on the outside to improve heat transfer efficiency. The thermal transfer device 250 may also be located such that the dehumidified housing 200 channels rain water to flow over the side 252 (and optionally the fins 254a) of the thermal transfer device 250 to cause the thermal transfer device 250 to cool faster than the inside of the enclosure 202 during rain. This may increase heat transfer efficiency during rapid temperature changes that may occur during sudden rain storms. In use, the dehumidified housing 200 may be oriented with the thermal transfer device 250 facing North to provide shading from the sun such that the thermal transfer device 250 is cooler than the other side of the enclosure 202.

The thermal transfer device 250 may be made of a material that is thermally conductive, acts as a catalyst to condensation, and retards mildew. A reverse thermocouple device may also be coupled to the thermal transfer device 250 to facilitate heat transfer. Those skilled in the art will recognize that other types of thermal transfer devices 250 may also be used.

In an alternative embodiment, a fan may be located after the thermal transfer device 250 to draw the cooled air from the thermal transfer device 250 and to direct the cooled air to the equipment 204. Those skilled in the art will recognize that other devices may also be used to direct and channel air through the enclosure 202.

The dehumidification system 210 may also include a drain system 260 coupled to the thermal transfer device 250 to collect the water and drain the water from the enclosure 202. The drain system 260 may include a collection basin 262 and a drain tube 264. The collection basin 262 may be located generally below the thermal transfer device 250 to collect the water from the thermal transfer device 250. The drain tube 264 may be coupled between the collection basin 262 and the enclosure 202 to drain the water to the outside of the enclosure 202. The collection basin 262 may also be made of a material, which is thermally conductive and prevents the growth of mold or mildew.

In use, the collection basin 262 and the drain tube 264 may drain the water using gravity and lack of suction. The drainage may be a function of the natural heating and cooling cycles in the surrounding environment. When the internal pressure inside of the enclosure 202 falls during a cooling down period (e.g., at night), a partial vacuum may be created that prevents water from draining. The drain tube 264 may include a flap or other device to prevent water (e.g., from rain) from being drawn up through the tube 264 when the enclosure is cooled suddenly (e.g., by rain). When the internal pressure rises during the next heating cycle (e.g., in the morning), the residual moisture in the collection basin 262 may then be forced out through the drain tube 264.

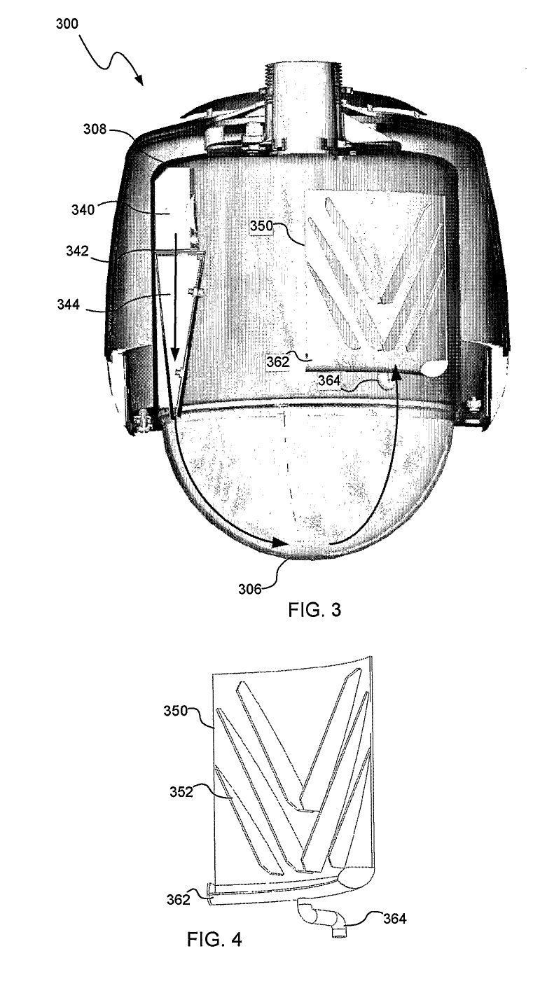

A further embodiment of a dehumidified equipment housing 300 is shown in FIG. 3. The dehumidified equipment housing 300 may include a blower fan 340 that passes air through heat coils 342 within an enclosure 308. A chute 344 channels the air passing through the heat coils 342 and directs the air into a bubble portion 306. The dehumidified equipment housing 300 may also include a thermal transfer device 350 that transfers heat from the air passing over the thermal transfer device 350 and condenses moisture. A collection basin 362 is coupled below the thermal transfer device 350 to collect the water running down from the thermal transfer device 350. A drain tube 364 is coupled to the collection basin 362 to drain the water from the enclosure 308, as described above.

One embodiment of the thermal transfer device 350, collection basin 362 and drain tube is shown in greater detail in FIG. 4. The thermal transfer device 350 may include fins 352 that are angled to direct the water into the collection basin 362. Although the collection basin 362 is shown as extending the entire width of the thermal transfer device 350, a collection basin may be designed to extend only across the region where the water is channeled by the fins 352. The thermal transfer device 350 may also include optional fins on the other side (not shown), which faces the outside of the enclosure 308. The thermal transfer device 350 may have a curved shape that conforms to the shape of the enclosure 308.

Accordingly, a dehumidification system and method used in an equipment housing may prevent condensation on a target region (e.g., on a bubble portion of a video dome housing). The dehumidification system and method may also control the location of condensation in the housing and the removal of moisture from the housing to prevent condensation from affecting the equipment or other areas inside of the housing.

Consistent with one embodiment of the present invention, a dehumidified equipment housing may include an enclosure configured to enclose equipment, a defroster, and a condenser. The defroster may be configured to receive air from the equipment and to direct the air to a target region on the enclosure such that the air prevents condensation on the target region. The condenser may be configured to receive air from the target region, to condense moisture in the air, to drain the moisture from the enclosure, and to direct dehumidified air to the equipment.

Consistent with another embodiment of the present invention, a dehumidification method may include directing heated air from equipment toward a target region on an enclosure enclosing the equipment to prevent condensation on the target region such that the heated air is partially cooled while passing over the target region. The dehumidification method may also include directing the partially cooled air from the target region on the enclosure to a thermal transfer device such that the partially cooled air is cooled further while passing over the thermal transfer device to cause condensation of water. The dehumidification method may also include draining the water to a region outside of the enclosure and directing the further cooled air to the equipment.

Consistent with a further embodiment of the present invention, a dehumidified dome housing may include a main enclosure portion configured to enclose equipment and a transparent bubble portion configured to be removably coupled to the main enclosure portion. The dehumidified dome housing may also include a thermal transfer device configured to transfer heat from the air in the equipment enclosure portion and to cause condensation of water. The thermal transfer device may be integrated into a side of the main enclosure portion. The dehumidified dome housing may further include a drain system coupled to the thermal transfer device and extending to a region outside of the equipment enclosure portion. The drain system may be configured to receive the water and to drain the water outside of the equipment enclosure portion such that condensation is prevented from accumulating on the bubble portion.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A dehumidified equipment housing comprising:
an enclosure configured to enclose equipment;
a defroster configured to receive air from said equipment and to direct said air to a target region on said enclosure such that said air prevents condensation on said target region; and
a condenser configured to receive air from said target region, to condense moisture in said air, to drain said moisture from said enclosure, and to direct dehumidified air to said equipment.

2. The dehumidified equipment housing of claim 1 wherein said enclosure is configured to enclose a camera, and wherein said target region on said enclosure includes a transparent region of said enclosure.

3. The dehumidified equipment housing of claim 1 wherein said defroster comprises a fan configured to draw air from said equipment and to direct said air to said target region on said enclosure.

4. The dehumidified equipment housing of claim 3 wherein said defroster further comprises a heater configured to heat said air directed by said fan before said air reaches said target region on said enclosure.

5. The dehumidified equipment housing of claim 1 wherein said condenser comprises:
a thermal transfer device integrated into a side of said enclosure and configured to transfer heat from said air to condense said moisture; and
a drain system coupled to said thermal transfer device and extending to a region outside of said enclosure, said drain system being configured to receive said water and to drain said water outside of said enclosure.

6. The dehumidified equipment housing of claim 5 wherein said thermal transfer device is located in an upper portion of said enclosure.

7. The dehumidified equipment housing of claim 5 wherein said drain system includes a collection basin and a drain tube coupled to said collection basin.

8. The dehumidified equipment housing of claim 5 wherein said thermal transfer device includes fins extending into said enclosure to facilitate heat transfer.

9. The dehumidified equipment housing of claim 1 wherein said enclosure includes a main enclosure portion and a transparent bubble portion removably coupled to said main enclosure portion, said target region including at least a portion of said bubble.

10. A dehumidification method comprising:
directing heated air from equipment toward a target region on an enclosure enclosing said equipment to prevent condensation on said target region, wherein said heated air is partially cooled while passing over said target region;
directing said partially cooled air from said target region on said enclosure to a thermal transfer device, wherein said partially cooled air is cooled further while passing over said thermal transfer device to cause condensation of water;
draining said water to a region outside of said enclosure; and
directing said further cooled air to said equipment.

11. The method of claim 10 wherein said target region on said enclosure includes a transparent region.

12. The method of claim 10 wherein said partially cooled air is directed upwards to said thermal transfer device.

13. The method of claim 10 further comprising heating air from said equipment to produce said heated air.

14. The method of claim 10 wherein said heated air is heated by said equipment.

15. The method of claim 10 wherein said enclosure includes a main enclosure portion and a transparent bubble portion removably coupled to said main enclosure portion, said target region including at least a portion of said bubble.

16. A dehumidified dome housing comprising:
a main enclosure portion configured to enclose equipment;
a transparent bubble portion configured to be removably coupled to said main enclosure portion;
a thermal transfer device configured to transfer heat from said air in said equipment enclosure portion and to cause condensation of water, said thermal transfer device being integrated into a side of said main enclosure portion; and
a drain system coupled to said thermal transfer device and extending to a region outside of said equipment enclosure portion, said drain system being configured to receive said water and to drain said water outside of said equipment enclosure portion such that condensation is prevented from accumulating on said bubble portion.

17. The dehumidified dome housing of claim 16 further comprising a fan configured to direct air from said equipment to said target region on said enclosure.

18. The dehumidified dome housing of claim 17 further comprising a heater configured to heat said air moved by said fan before said air reaches said target region on said enclosure.

19. The dehumidified dome housing of claim 16 wherein said thermal transfer device is located in an upper portion of said enclosure.

20. The dehumidified dome housing of claim 16 wherein said thermal transfer device has a curved shape conforming to a shape of said main enclosure portion, and wherein said thermal transfer device includes fins to facilitate heat transfer and angled to direct water toward said drain system.
